(19) United States
(12) Patent Application Publication
(10) Pub. No.: US 2009/0269266 A1
(43) Pub. Date: Oct. 29, 2009

(54) Oxidic Metal Composition, Its Preparation And Use As Catalyst Composition

(75) Inventors: Dennis Stamires, Dana Point, CA (US); Paul O'connor, Hoevelaken (NL); William Jones, Cambridge (GB); Erik Jeroen Laheij, Amstelveen (NL)

Correspondence Address: Albemarle Netherlands B.V.;Patent and Trademark Department, 451 Florida Street, Baton Rouge, LA, 70801, US

(73) Assignee: ALBEMARLE NETHERLANDS B.V., AMERSFOORT (NL)

(21) Appl. No.: 11/915,708

(22) PCT Filed: Jun. 2, 2006
(86) PCT No.: PCT/EP2006/062898

§ 371 Date: Jun. 5, 2009

Related U.S. Application Data
(60) Provisional application No. 60/687,312, filed on Jun. 6, 2005.

(51) Int. Cl. B01D 53/50; B01J 23/10; B01J 23/02; B01J 27/236; B01J 27/232

(52) U.S. Cl. 423/244.1; 502/303; 502/341; 502/176; 502/174; 423/244.09

(57) ABSTRACT

Oxidic composition consisting essentially of oxidic forms of a first metal, a second metal, and optionally a third metal, the first metal being either Ca or Ba and being present in the composition in an amount of from about 5 to about 80 wt %, the second metal being Al and being present in the composition in an amount of from about 5 to about 80 wt %, the third metal being selected from the group consisting of La, Ti, and Zr, and being present in an amount of from 0 to about 17 wt %—all weight percentages calculated as oxides and based on the weight of the oxidic composition, the oxidic composition being obtainable by

(a) preparing a physical mixture comprising solid compounds of the first, the second, and the optional third metal, (b) optionally aging the physical mixture, without anionic clay being formed, and (c) calcining the mixture.

This composition is suitable for use in FCC processes for the passivation of metals with only minimal influence on the zeolite's hydrothermal stability.

The present invention relates to a metal-doped mixed metal oxide composition and its use in catalytic processes, such as fluid catalytic cracking (FCC).

EP-A 0 554 968 (W.R. Grace and Co.) relates to a composition comprising a coprecipitated ternary oxide comprising 30-50 wt % MgO, 30-50 wt % Al₂O₃, and 5-30 wt % La₂O₃. The composition is used in a fluid catalytic cracking process for the passivation of metals (V, Ni) and the control of SOₓ emissions from the regenerator of the FCC unit.

U.S. Pat. No. 6,028,023 discloses the preparation of hydrotalcite-like compounds from MgO and Al₂O₃. These compounds are prepared by (a) preparing a reaction mixture comprising an Mg-containing compound and an Al-containing compound, thereby forming either a hydrotalcite-like compound or a non-hydrotalcite-like compound, followed by calcination and rehydration. The resulting compound is used in an FCC process for the reduction of SOₓ emissions.

A disadvantage of the above compositions is that when they are incorporated into a zeolite-containing FCC catalyst, they have a negative effect on the zeolite's hydrothermal stability.

The object of the present invention is to provide a composition which is suitable for use in FCC processes for the reduction of SOₓ emissions from the regenerator and for the production of sulphur-lean fuels, while at the same time this composition has a minimised influence on the zeolite's hydrothermal stability.

The present invention relates to a mixed metal oxide composition comprising (i) at least two gel-forming metals in a total amount of 90-99.9 wt %, said metals being selected from the group consisting of Ti, Zr, Ce, La, Al, Cr, P, and Fe, and (ii) a metal dopant in an amount of 0.1-10 wt % which is selected from the group consisting of W, Pt, Pd, Rh, V, Mo, Co, Ni, Mn, and combinations thereof, all weight percentages calculated as oxides and based on the total weight of the composition, said composition being obtainable by
a) adding a base to an aqueous solution comprising water-soluble trivalent or tetravalent salts of said gel-forming metals, thereby forming a gel,
b) adding the metal dopant(s) to the gel to obtain a doped gel, and
c) optionally calcining the doped gel.

### Step a)

The mixed metal oxide composition according to the present invention is obtainable by a process which involves as a first step the addition of a base to an aqueous solution comprising the at least two gel-forming metals in the form of water-soluble trivalent or tetravalent salts. Suitable bases include sodium hydroxide, ammonium hydroxide, and potassium hydroxide. Ammonium hydroxide is the preferred base, because it leaves no alkali metal in the resulting composition. The resulting gel contains the at least two gel-forming metals.

The at least two gel-forming metals are selected from Ti, Zr, Ce, La, Al, Cr, P, and Fe. Suitable salts of these metals to be present in the aqueous solution are Ti(IV), Zr(IV), Ce(IV), La(III), AI(III), Cr(III), Fe(III), and phosphorus-containing salts. Examples of such salts are the nitrate and chloride salts of these metals, the ammonium salts of W, Mo, and V, and the sulphate salts of the metals, for example zirconyl sulphate.

### Step b)

The metal dopant is added to the gel formed in step a), either during or after formation of the gel.

The metal dopant is selected from the group consisting of W, Pt, Pd, Rh, V, Mo, Co, Ni, Mn, and combinations thereof. The dopant is preferably added to the gel as a water-soluble salt.

The gel may optionally be aged, dried, and/or shaped to form particles and the metal dopant can be added during this optional shaping step or after the optional aging, drying, and/or shaping steps.

If the dopant is added after formation of the gel but before an optional drying step, it is preferably introduced during high-shear mixing of the gel in order to improve the dispersion of the dopant in the gel. If the dopant is added after a drying or shaping step, it is preferably introduced by impregnating the dried and/or shaped gel with a solution comprising the dopant.

Suitable aging conditions are temperatures in the range 20-300° C., preferably 50-160° C., and autogeneous pressure. Aging is preferably conducted from 0.5-6 hours, more preferably 0.5-24 hours, most preferably 1-6 hours. Suitable drying methods include spray-drying, flash-drying, flash-calcining, and air drying.

Suitable shaping methods include spray-drying (a method which combines shaping with drying), extrusion, beading, and pelletising.

### Step c)

The doped gel, which may or may not be aged, dried, and/or shaped, may be calcined at a temperature in the range of 200-1000° C., more preferably 400-800° C., and most preferably 350-600° C. Calcination is preferably conducted for 0.5-6 hours, preferably 1-4 hours. All commercial types of calciners can be used, such as fixed bed or rotating calciners. Calcination can be performed in various atmospheres, e.g, in air, oxygen, inert atmosphere (e.g. N₂), steam, or mixtures thereof.

The mixed metal oxide according to the present invention comprises the at least two gel-forming metals in a total amount of 90-99.9 wt %, preferably 95-99 wt %, calculated as oxides and based on dry solids weight. Said gel-forming metals are preferably present in the composition in about equimolar amount. The dopant is present in the composition in an amount of 0.1-10 wt %, preferably 1-5 wt %, calculated as oxides and based on dry solids weight.

As a result of the preparation method, the composition according to the invention contains the gel-forming metals and the metal dopant in a high dispersion, meaning that the metal oxides in the composition are more intimately mixed than in an assembly of discrete metal oxide particles.

### Use of the Oxidic Composition

The mixed metal oxide composition according to the invention can suitably be used in or as a catalyst or catalyst additive or sorbent in a hydrocarbon conversion, purification, or synthesis process, particularly in the oil refining industry and Fischer-Tropsch processes. Examples of processes where these compositions can suitably be used are catalytic cracking, hydrogenation, dehydrogenation, hydrocracking, hydroprocessing (hydrodenitrogenation, hydrodesulphurisation, hydrodemetallisation), polymerisation, steam reforming, base-catalysed reactions, gas-to-liquid conversions (e.g. Fischer-Tropsch), and the reduction of SOₓ and NOₓ emissions from the regenerator of an FCC unit. The mixed metal oxide composition according to the invention may also be used in biomass conversion processes.

In particular, the composition is very suitable for use in FCC processes for the reduction of SOₓ emissions and the production of fuels (like gasoline and diesel) with a low S and N content.

The mixed metal oxide composition according to the invention can be added to the FCC unit as such, or it can be incorporated into an FCC catalyst, resulting in a composition which besides the mixed metal oxide composition according to the invention comprises conventional FCC catalyst ingredients, such as matrix or filler materials (e.g. clays such as kaolin, titanium oxide, zirconia, alumina, silica, silica-alumina, bentonite, etc.), and molecular sieve material (e.g. zeolite Y, USY, REY, RE-USY, zeolite beta, ZSM-5, etc.). Therefore, the present invention also relates to a catalyst particle containing the mixed metal oxide composition according to the invention, a matrix or filler material, and a molecular sieve.

### EXAMPLES

### Example 1

A precipitate was formed by adding ammonium hydroxide to an aqueous solution comprising cerium nitrate and zirconyl sulphate in equimolar amount. A gel was formed. The gel was divided into two parts: The first part was aged at 65° C. for 8 hours and the other was aged at room temperature for 2 hours.

Under high-shear mixing, 5 wt % ammonium metatungstate (calculated as metal oxides and based on the total solids content) was added to both gel portions. The gel portions were diluted to a solids content of 30 wt % and then spray-dried to form microspheres.

The resulting materials were mixed with a regular FCC catalyst and tested in an MAT unit. The results indicated a reduction in SOₓ emissions and the sulphur content of the gasoline compared to the FCC catalyst on its own.

### Example 2

Example 1 was repeated, except that the 5 wt % ammonium metatungstate was replaced by 8 wt % ammonium metavanadate.

### Example 3

Example 1 was repeated, except that the 5 wt % ammonium metatungstate was replaced by 10 wt % rhodium chloride.

### Example 4

A precipitate was formed by adding sodium hydroxide to an aqueous solution comprising cerium nitrate and titanium chloride in equimolar amount. A gel was formed. The gel was aged at 65° C. for 2 hours.

Under high-shear mixing, 2 wt % ammonium metatungstate (calculated as metal oxides and based on the total solids content) was added to the gel. The gel was diluted to a solids content of 30 wt % and then spray-dried to form microspheres.

The microspheres were calcined at 500° C. for 2 hours.

The resulting materials were mixed with a regular FCC catalyst and tested in an MAT unit. The results indicated a reduction in SOx emissions and the sulphur content of the gasoline compared to the FCC catalyst on its own.

### Example 5

Example 4 was repeated, except that iron(III) nitrate was used instead of titanium chloride and the amount of ammonium metatungstate was 4 wt %.

### Example 6

Example 5 was repeated, except that the precipitate was formed from cerium nitrate, zirconyl sulphate, and iron(III) nitrate in equimolar amounts.

### Example 7

A precipitate was formed by adding sodium hydroxide to an aqueous solution comprising cerium nitrate and titanium chloride in equimolar amount. A gel was formed. The gel was diluted to a solids content of 30 wt % and then spray-dried to form microspheres.

The microspheres were then impregnated with a solution of chloroplatinic acid (2 wt % Pt) and subsequently flash-dried and calcined at 500° C. for 2 hours. The resulting composition was mixed with a regular FCC catalyst and tested in an MAT apparatus. It showed a reduction of the S content of the gasoline compared to the FCC catalyst on its own.

1. A composition consisting essentially of oxidic forms of a first metal, a second metal, and optionally a third metal, the first metal being either Ca or Ba and being present in the composition in an amount of from about 5 to about 80 wt %, the second metal being Al and being present in the composition in an amount of from about 5 to about 80 wt %, the third metal being selected from the group consisting of La, Ti, and Zr, and being present in an amount of from 0 to about 17 wt %—all weight percentages calculated as oxides and based on the weight of the oxidic composition, the oxidic composition being obtainable by
a) preparing a physical mixture comprising solid compounds of the first, the second, and the optional third metal,
b) optionally aging the physical mixture, without anionic clay being formed, and
c) calcining the mixture.

2. The composition according to claim 1 wherein the solid compounds of the first, the second, and the optional third metal are oxides, hydroxides, carbonates, or hydroxycarbonates.

3. The composition according to claim 1 wherein the first metal is present in an amount of from about 10 to about 50 wt %, calculated as oxide and based on the weight of the oxidic composition.

4. The composition according to claim 1 wherein the second metal is present in an amount of from about 20 to about 60 wt %, calculated as oxide and based on the weight of the oxidic composition.

5. The composition according to claim 1 wherein the third metal is present in an amount of from about 3 to about 15 wt %, calculated as oxide and based on the weight of the oxidic composition.

6. A catalyst particle comprising an oxidic composition consisting essentially of oxidic forms of a first metal, a second metal, and optionally a third metal, the first metal being either Ca or Ba and being present in the composition in an amount of from about 5 to about 80 wt %, the second metal being Al and being present in the composition in an amount of from about 5 to about 80 wt %, the third metal being selected from the group consisting of La, Ti, and Zr, and being present in an amount of from 0 to about 17 wt %—all weight percentages calculated as oxides and based on the weight of the oxidic composition, a matrix or filler material, and a molecular sieve.

7. (canceled)

8. A process for the conversion, purification or synthesis of a hydrocarbon comprising the step of contacting the hydrocarbon with an oxidic composition consisting essentially of oxidic forms of a first metal, a second metal, and optionally a third metal, the first metal being either Ca or Ba and being present in the composition in an amount of from about 5 to about 80 wt %, the second metal being Al and being present in the composition in an amount of from about 5 to about 80 wt %, the third metal being selected from the group consisting of La, Ti, and Zr, and being present in an amount of from 0 to about 17 wt %—all weight percentages calculated as oxides and based on the weight of the oxidic composition.

9. The process of claim 8 wherein the oxidic composition is used to passivate Ni or vanadium in an FCC process.
